(19) United States
(12) Patent Application Publication
(10) Pub. No.: US 2011/0172943 A1
(43) Pub. Date: Jul. 14, 2011

(54) ZERO-POINT SETTING METHOD AND APPARATUS FOR ELECTRONIC SCALES

(75) Inventors: Benjamin K. Roberts, Portland, OR (US); Aric B. Zandhuisen, Eugene, OR (US); Charles R. Polley, III, Eugene, OR (US); Jeffrey T. Robson, Eugene, OR (US); Harold T. Clifford, Eugene, OR (US); Alan J. Guess, Veneta, OR (US)

(73) Assignee: Datalogic Scanning, Inc., Eugene, OR (US)

(21) Appl. No.: 13/004,600

(22) Filed: Jan. 11, 2011

Related U.S. Application Data
(60) Provisional application No. 61/294,056, filed on Jan. 11, 2010.
(60) Provisional application No. 61/294,379, filed on Jan. 12, 2010.

(51) Int. Cl. G06F 19/00; G01G 23/01

(52) U.S. Cl. 702/87

(57) ABSTRACT

An exemplary apparatus/system or method for establishing initial zero-points and current zero-points includes an initial zero device programmed to establish an initial zero-point and a semi-automatic zero device programmed to either establish a current zero-point or to reset or power cycle a scale when a current zero-point cannot be established.

### RELATED APPLICATIONS

This application claims priority under 35 U.S.C. §119(e) to U.S. Application No. 61/294,056 filed on Jan. 11, 2010 and to U.S. Application No. 61/294,379 filed on Jan. 12, 2010, both of which are fully incorporated herein by reference.

### BACKGROUND

The field of the present disclosure relates to electronic weighing instruments in general, and specifically to methods and devices for establishing zero-points for an electronic scale.

Electronic scales are important commercial tools used to determine the weight of various objects in numerous settings. A common example is an electronic scale, such as those used at grocery stores, used singly or operatively connected to other electronics such as a data reader, point of sale system, or other suitable electronic equipment. Electronic scales are commonly calibrated by the manufacturer or a certified individual to establish an absolute zero-point. The term “zero-point” is used to designate a weight detected by an electronic weighing instrument where the detected weight is associated with a display of “0” units of weight measurement, such as pounds, kilograms, etc. An absolute zero-point typically provides a zero indication, such as the numeral “0” shown on an electronic display, when the electronic weighing instrument detects no object on the scale. In other words, the absolute zero-point, or calibrated zero-point, corresponds to the weight detected by an electronic scale when it detects the weight of its own components, such as a weigh platter.

Maintenance and repair costs associated with electronic scales having only an absolute zero-point are relatively high because the absolute zero-point should be maintained to facilitate use of the electronic scale, or the scale should be recalibrated from time-to-time to re-establish the absolute zero-point. If a scale component is replaced, becomes worn, or is damaged, the electronic scale will detect a weight different from the weight used to establish the absolute zero-point and will provide an indication other than zero when there is no object to be weighed unless the absolute zero-point is recalibrated. Thus, use and maintenance of the electronic scale may be cumbersome and relatively expensive.

Two common devices developed to address the situation when an electronic scale does not detect the absolute zero-point are an initial zero device and a semi automatic zero device. An initial zero device operates when an electronic scale is powered on, and uses the weight detected when powered on to establish an initial zero-point. Thus, whatever weight is detected at power on, such as the weight of the electronic scale components alone or the weight of such components plus the weight of an object, is associated with the initial zero-point. A semi-automatic zero device operates after power on and uses the weight detected when the semi-automatic zero device is activated to establish a current zero-point. Semi-automatic zero devices are commonly activated by an operator pressing a “0” or “zero” button on an electronic scale.

Organisation Internationale De Métrologie Légale (OIML) International Recommendation R 76-1:2006(E) establishes technical requirements for non-automatic weighing instruments. Section 4.5 of OIML R 76-1:2006(E) governs semi-automatic zero devices. Specifically, subsection 4.5.1 provides that the overall effect of semi-automatic zero devices shall not be more than 4% of the maximum weighing capacity of the instrument. In other words, the semi-automatic zero device may establish a current zero-point if the electronic scale detects a weight change that falls within a range having an upper limit and a lower limit where the difference between the upper limit and the lower limit is not more than 4% of the maximum weighing capacity of the scale.

Subsection 4.5.1 of OIML R 76-1:2006(E) also provides that the overall effect of an initial zero device shall not be more than 20% of the maximum weighing capacity of the instrument. In other words, the initial zero device may establish an initial zero-point if the electronic scale detects a weight that falls within a weight range having an upper limit and a lower limit where the difference between the upper limit and the lower limit is not more than 20% of the maximum weighing capacity of the scale.

The present inventors have recognized various problems associated with electronic scales that comply with the above technical requirements of OIML R 76-1:2006(E). One such problem relates to electronic scales establishing an initial zero-point when a relatively heavy object is on the scale at power on. Removal of the object after power is supplied to the electronic scale causes the scale to be unable to establish a current zero-point. Another such problem relates to electronic scales limited to establishing an initial zero-point only with a relatively light weight on the scale. Subsequent wear or damage to such a scale commonly results in a relatively heavy phantom weight detected by the scale and prevents the scale from establishing an initial zero-point.

### SUMMARY

Embodiments of the present invention may address some or all of the above identified limitations and/or needs, or may address other suitable needs. An exemplary apparatus/system or method for establishing initial zero-points and current zero-points includes an initial zero device programmed to establish an initial zero-point and a semi-automatic zero device programmed to establish a current zero-point or to reset or power cycle a scale when a current zero-point cannot be established.

Additional aspects and advantages will be apparent from the following detailed description of preferred embodiments, which proceeds with reference to the accompanying drawings.

### BRIEF DESCRIPTION OF THE DRAWINGS

FIG. 1 illustrates a chart of a hypothetical initial zero range and a hypothetical semi-automatic zero range for a hypothetical scale.

FIG. 2 illustrates a block diagram for a preferred embodiment.

FIG. 3 illustrates a flow chart for a preferred embodiment.

### DETAILED DESCRIPTION OF PREFERRED EMBODIMENTS

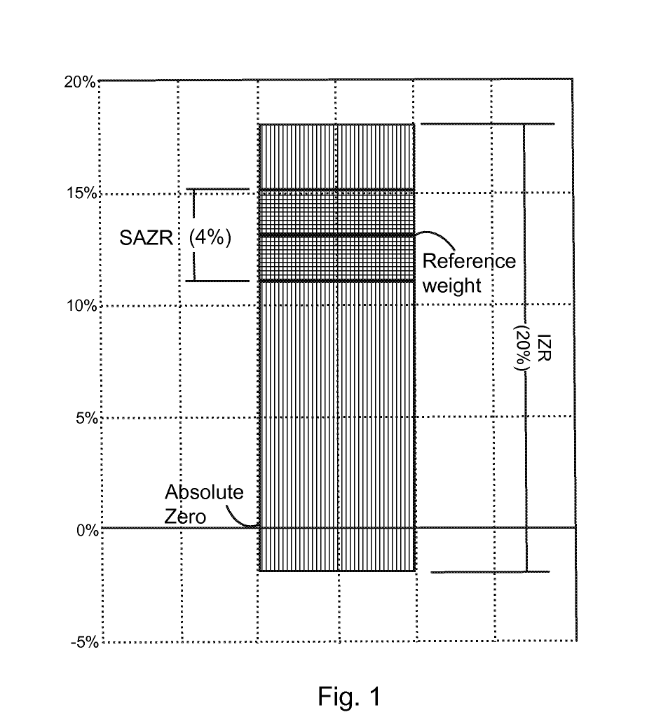

The present inventors have recognized various problems associated with electronic scales having initial zero devices and semi-automatic zero devices that conform to the technical requirements of OIML R 76-1:2006(E). One such problem relates to powering on an electronic scale bearing an initial weight other than the weight of the instrument's own components. FIG. 1 illustrates a hypothetical exemplary initial zero range (IZR) and a hypothetical exemplary semi-automatic zero range (SAZR) for a hypothetical electronic scale. In FIG. 1 the IZR is from −2% of the scale's maximum weighing capacity to +18% of the scale's maximum weighing capacity. To conform with OIML R 76-1:2006(E) the IZR may have alternate lower and upper limits as long as the difference between the lower and upper limits does not exceed 20% of the scale's maximum weighing capacity.

When currently existing electronic scales are powered on, such electronic scales detect an initial weight. If the initial weight is outside the IZR, a fault is detected and the electronic scale is made inoperative until some or all of the initial weight is removed. Once enough of the initial weight has been removed to fall within the IZR, the initial zero device establishes an initial zero-point based on the initial weight and the instrument's display outputs a zero reading while the initial weight is on the scale. Alternately, if the initial weight falls within the IZR the initial zero device establishes an initial zero-point and the display outputs a zero reading. As illustrated in FIG. 1, if the initial weight weighs 13% of the scale's maximum weighing capacity, the initial zero-point is established based on having the initial weight on the scale.

The electronic scale may be used to weigh objects with the initial weight in place, but commonly the initial weight is removed. With reference to FIG. 1, removing the initial weight results in the scale changing from detecting 13% of the maximum weighing capacity to 0% of the maximum weighing capacity. When the initial weight is removed currently existing scales commonly detect a fault, for example, a negative weight resulting from removing the weight used to establish the initial zero-point. A common action currently existing scales take in response to removing the initial weight used to establish the initial zero-point is to display a flashing “-0-” symbol, or to present another suitable symbol.

When the flashing “-0-” symbol appears, scale operators typically activate a semi-automatic zero device by pushing a “0” or “zero” button to establish a current zero-point. However, under the requirements of OIML R 76-1:2006(E) a semi-automatic zero device can only establish a current zero-point if the detected weight on the scale is within 4% of the maximum weighing capacity of the scale compared to the last weight used to establish a zero-point. For the hypothetical example illustrated in FIG. 1, the initial zero-point was established using a weight of 13% of the maximum weighing capacity. The illustrated 4% range within which the semi-automatic zero device must operate is with a weight between 15% and 11%, inclusive, of maximum weighing capacity on the scale. Alternate upper and lower limits may be used for the SAZR as described below.

However, when the 13% of maximum weighing capacity initial weight used to establish the initial zero-point is removed, the scale detects 0% of the maximum weighing capacity and the semi-automatic zero device cannot establish a current zero-point because of the technical requirements of OIML R 76-1:2006(E). Therefore, pressing a “0” or “zero” button does not cause the semi-automatic zero device in typical, current electronic scales to establish a zero-point under such circumstances.

When typical, current semi-automatic zero devices cannot establish a current zero-point, for example, because an under or over weight condition outside the 4% maximum weighing capacity range exists, the same flashing “-0-” symbol, or other suitable symbol, is typically provided as an indication that a current zero-point cannot be established. In response, operators commonly attempt to establish a current zero-point by activating the semi-automatic zero device, but do not understand what to do when a current zero-point cannot be established. Typically operators make a service request for the electronic scale when a current zero-point cannot be established. Such service requests are expensive due to the electronic scale's downtime and the cost associated with a technician visiting and servicing the electronic scale.

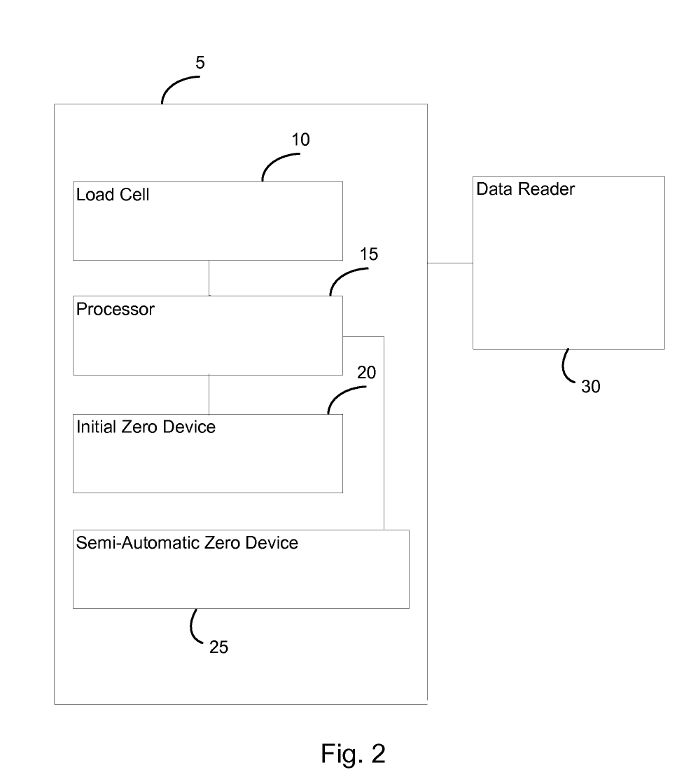

A preferred system and method for establishing zero-points for an electronic scale address the inability of current electronic scales with an initial zero device and a semi-automatic zero device to establish a current zero-point after a relatively heavy item used to establish an initial zero-point is removed from a scale. FIG. 2 provides a block illustration for a preferred system. A scale 5 includes a weight detecting device 10 such as a load cell (which may be mechanical, strain gage, etc.) operatively coupled to a processor 15. The processor 15 is also operatively coupled to an initial zero device 20 and a semi-automatic zero device 25. Alternately, one or more of processor 15, initial zero device 20, and semi-automatic zero device 25 may be located in a data reader 30 or other suitable electronic equipment operatively coupled to scale 5.

The initial zero device 20 and semi-automatic zero device 25 are preferably embodied as programmable logic and may each include one or more of hardware, firmware, software, or other suitable programmable logic. In an alternate embodiment, initial zero device 20 and semi-automatic zero device 25 may be included as part of processor 15.

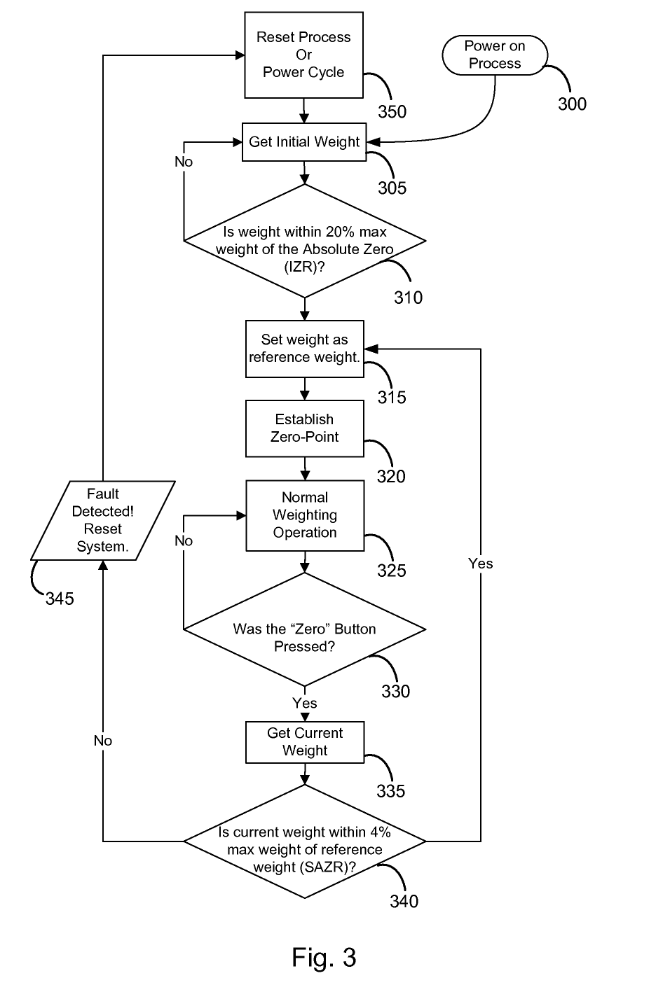

The initial zero device 20 and semi-automatic zero device 25 are preferably programmed to carry out certain of the method steps illustrated in FIG. 3. At step 300, an operator powers on scale 5. When power is provided to scale 5 the weight detecting device 10 detects an initial weight on scale 5. For example, when a cashier opens a checkout lane the cashier brings a cash drawer to be placed in a point of sale system that is operatively coupled to scale 5. The cashier may set the cash drawer down and some or all of the cash drawer may rest on scale 5. When the cashier turns on the point of sale system, power is supplied to scale 5 which has an initial weight on it resulting from the cash drawer. There are numerous other circumstances in which an initial weight might be placed on a scale before power is supplied to the scale.

The initial zero device 20 is programmed to execute an initial zero process. FIG. 3 illustrates an exemplary flow chart including an initial zero process. For step 305 the initial zero device 20 is preferably programmed to receive a signal indicative of the amount of the initial weight, for example, from the processor 15 or directly from the weight detecting device 10. For step 310, the initial zero device 20 is preferably programmed to determine whether the initial weight falls within the IZR. For example, the initial zero device 20 may be programmed with the maximum weighing capacity of scale 5 and to mathematically determine whether the initial weight is less than or equal to 20% of the maximum weighing capacity. Alternately, initial zero device 20 may be programmed with the upper and lower weight limits for the IZR and further programmed to determine whether the initial weight is less than or equal to the upper weight limit and greater than or equal to the lower weight limit.

For step 310, if the initial weight is outside the IZR the initial zero device 20 is preferably programmed to determine that an initial zero-point cannot be established. When an initial zero-point cannot be established, the initial zero device 20 is also programmed to return to step 305 to restart the initial zero process.

For step 310, if the initial weight is within the IZR, the initial zero device 20 is preferably programmed to proceed to step 315 where the initial zero device 20 is programmed to set the initial weight as a reference weight. At step 320 the initial zero device 20 is programmed to establish the reference weight as the initial zero-point.

For step 325 the processor 15 is programmed to use the initial zero-point in conjunction with signals received from the weight detecting device 10 to carry out weighing operations for items placed on scale 5.

The semi-automatic zero device 25 is programmed to execute a current zero process. For step 330, the semi-automatic zero device 25 is programmed to determine whether the semi-automatic zero device 25 has been activated. For example, the semi-automatic zero device 25 may be programmed to receive a signal generated by an operator pressing a “0” or “zero” button on scale 5. If the semi-automatic zero device 25 does not detect an activation signal, then the processor 15 continues to perform weighing operations at step 325.

If the semi-automatic zero device 25 detects an activation signal at step 330, it is programmed to receive a signal indicative of the amount of the current weight for step 335, for example, from the processor 15 or directly from the weight detecting device 10. For step 340, the semi-automatic zero device 25 is programmed to determine whether the current weight falls within the SAZR. According to OIML R 76-1:2006(E), the difference between the upper and lower limits of the SAZR can be no more than 4% of the maximum weighing capacity of scale 5. Additionally, the difference between the upper or lower limit of the SAZR and the initial zero-point can be no more than 4% of the maximum weighing capacity of scale 5. For example, FIG. 1 illustrates the SAZR as +/−2% of the maximum weighing capacity with respect to the initial zero-point which is 13% of the maximum weighing capacity. Alternately, the lower limit of the SAZR could be the same as the initial zero-point and the upper limit could be +4% of the maximum weighing capacity with respect to the initial zero-point. Other suitable lower and upper limits, such as the lower limit being −1% of the maximum weighing capacity and the upper limit being +3% of the maximum weighing capacity, both with respect to the initial zero-point, could be established for the SAZR. The semi-automatic zero device 25 is preferably programmed to define the SAZR with respect to the currently existing zero-point and to mathematically determine whether the current weight is greater than or equal to the lower limit of the SAZR and whether the current weight is less than or equal to the upper limit of the SAZR.

Note that the weights corresponding to the upper and lower limits of the SAZR will change each time a zero-point is established because the SAZR is based on the currently existing zero-point. In contrast, the weights corresponding to the upper and lower limits of the IZR preferably do not change as it is preferable to have the same IZR used each time scale 5 is powered on or is reset.

For step 340, if the current weight is within the SAZR, the semi-automatic zero device 25 is preferably programmed to proceed to step 315 where the semi-automatic zero device 25 is programmed to set the current weight as the reference weight. At step 320 the semi-automatic zero device 25 is programmed to establish the reference weight as the current zero-point. Alternately, the semi-automatic zero device 25 may be programmed to pass the current weight to the initial zero device 20 and the initial zero device 20 may be programmed to set the current weight as the reference weight at step 315 and to establish the reference weight as the current zero-point at step 320.

For step 325 the processor 15 is programmed to use the current zero-point in conjunction with signals received from the weight detecting device 10 to carry out weighing operations for items placed on scale 5.

For step 340, the semi-automatic zero device 25 is preferably programmed to determine whether the current weight is outside the SAZR. If the semi-automatic zero device 25 determines the current weight is outside the SAZR, the semi-automatic zero device 25 is preferably further programmed to proceed to step 345 and determine that a fault has occurred. At step 345 the semi-automatic zero device 25 is also preferably programmed to automatically make scale 5 inoperable, or to provide a visual or audible indication of the fault.

The semi-automatic zero device 25 is preferably further programmed to initiate a reset or power cycle procedure for scale 5 at step 350. A reset or power cycle procedure may include clearing the existing zero-point and the reference weight and restarting processing with the initial zero device 20 at step 305. Alternately, a reset or power cycle procedure may include shutting down scale 5 and restarting scale 5 without operator intervention followed by processing starting with the initial zero device 20 at step 305.

Operation of a preferred initial zero device 20 and semi-automatic zero device 25 thus provides improved operation for scale 5 compared to currently existing initial zero and semi-automatic devices. As discussed above, current electronic scales complying with OIML R 76-1:2006(E) typically cannot establish a current zero-point after a relatively heavy item present when establishing an initial zero-point is thereafter removed from the scale. Such failure to establish a current zero-point commonly results in a service request for the scale, often because the operator does not understand the meaning of the flashing “-0-” symbol. In contrast, after a relatively heavy item was present when establishing an initial zero-point is thereafter removed from the scale 5, using an initial zero device 20 and a semi-automatic zero device 25 programmed to execute the method discussed above and illustrated in FIG. 3, or an equivalent method, results in scale 5 being reset or power cycled and restarts processing with the initial zero device 20. Thus, scale 5 utilizes the initial zero device 20 after a fault determination is made by the semi-automatic zero device 25, and preferably after providing a visual or audible indication that the scale 5 is responding to the fault, unlike common currently existing scales which typically render the scale inoperable after detecting the fault and stop processing unless the weight on the scale is brought back within the SAZR and the “zero” button is pressed.

The present inventors have recognized another problem related to electronic weighing instrument manufacturers limiting a currently existing initial zero device to establishing an initial zero-point only when an initial weight (in addition to the weight of the electronic weighing instrument's own components used to establish the absolute zero-point) does not exceed 4% of the electronic scale's maximum weighing capacity. Placing such a 4% limitation on currently existing initial zero devices permits a currently existing automatic zero device to consistently establish a current zero-point when an initial weight is removed. However, if a scale component is replaced (for example, with a component having a weight that is greater than 4% of the electronic scale's maximum weighing capacity), becomes worn, or is damaged, the scale may detect a real weight (for example, due to a replaced component) or a phantom weight (for example, due to a false reading caused by a worn or damaged component) that exceeds the 4% limitation imposed on the initial zero device. In such a situation neither a currently existing initial zero device nor a currently existing semi-automatic zero device can establish a zero-point and the scale needs to be recalibrated or repaired.

However, using an initial zero device 20 and a semi-automatic zero device 25 programmed to execute the method discussed above and illustrated in FIG. 3, or other suitable method, may result in a more robust and durable scale 5 that can consistently establish a current zero-point and can establish an initial zero-point after sustaining similar or greater damage, wear, or part replacement as compared to existing scales.

Consider a currently existing scale having a maximum weighing capacity of 100 pounds and an initial zero device that is limited to establishing an initial zero-point only when the initial weight detected by the scale is 4 pounds or less. Components of the scale may become damaged if a relatively heavy item, such as a frozen turkey, is dropped onto the scale. For example, the scale may include a processor communicating with a load cell having multiple strain gages attached to a beam. When the beam deflects, the electrical resistance of the strain gages proportionally changes and the processor can determine the weight of the item causing the beam to deflect. If the frozen turkey dropped on the scale causes a permanent deformation of the beam to a position where the processor determines there is 7 pounds on the scale, when the scale is next cycled off and then back on the processor will detect a phantom weight of 7 pounds. That is, the processor will detect a 7 pound weight that is not actually present due to the permanently deflected beam. Therefore, when the scale is powered on, the initial zero device will not be able to establish an initial zero-point because the 7 pound phantom weight exceeds the 4 pound limitation placed on the initial zero device. Likewise, the semi-automatic zero device will not be able to establish a current zero-point because there is no existing zero-point from which to determine the SAZR. The scale will thus need to be recalibrated or repaired before it can be used again.

In one example implementation, a scale 5 is provided having a maximum weighing capacity of 100 pounds, an initial zero device 20, and a semi-automatic zero device 25 (where both the initial zero device 20 and the semi-automatic zero device 25 are programmed to execute the method discussed above and illustrated in FIG. 3). As described above, the initial zero device 20 can take full advantage of the 20% of the maximum weighing capacity permitted under OIML R 76-1:2006(E). Therefore, if a frozen turkey dropped on scale 5 damages scale components and causes processor 15 to detect a phantom weight of 7 pounds the initial zero device 20 will be able to establish an initial zero-point the next time scale 5 is powered on. Scale 5 may thus be more robust and durable when compared to currently existing scales and may require fewer service requests, recalibration procedures, or repairs.

The terms and descriptions used above are set forth by way of illustration only and are not meant as limitations. Those skilled in the art will recognize that many variations can be made to the details of the above-described embodiments without departing from the underlying principles of the invention. The scope of the present invention should, therefore, not be limited to the above specific examples, but is defined by the claims below.

1. An electronic scale comprising:
a weight detecting device;
an electronic initial zero device configured to receive signals indicative of a weight detected by the weight detecting device; and
an electronic semi-automatic zero device configured to receive signals indicative of a weight detected by the weight detecting device;
wherein the electronic initial zero device is programmed to determine whether a signal indicative of an initial weight detected by the weight detecting device when the electronic scale is powered on or is reset is within an initial zero range, and if so is further programmed to set an initial zero point based on the initial weight, and if not is further programmed to receive a new signal indicative of a new initial weight detected by the weight detecting device;
wherein the electronic semi-automatic zero device is programmed to determine whether a signal indicative of a new weight detected by the weight detecting device when the electronic semi-automatic zero device is activated indicates a weight within a semi-automatic zero range, and if so is further programmed to set a current zero-point based on the new weight, and if not is further programmed to initiate a reset or power cycle for the electronic scale.

2. An electronic scale according to claim 1, wherein:
the initial zero range includes an upper limit and a lower limit and the difference between the upper limit and the lower limit is equal to or less than 20% of a maximum weighing capacity of the electronic scale; and
the semi-automatic zero range includes an upper limit and a lower limit and the difference between the upper limit and the lower limit is equal to or less than 4% of the maximum weighing capacity of the electronic scale with respect to the initial zero-point.

3. An electronic scale according to claim 2, wherein:
the upper limit of the initial zero range equals +18% of the maximum weighing capacity of the electronic scale;
the lower limit of the initial zero range equals −2% of the maximum weighing capacity of the electronic scale;
the upper limit of the semi-automatic zero range equals +2% of the maximum weighing capacity of the electronic scale with respect to the initial zero-point; and
the lower limit of the semi-automatic zero range equals −2% of the maximum weighing capacity of the electronic scale with respect to the initial zero-point.

4. An electronic scale according to claim 1, further comprising a display;
wherein the electronic initial zero device is further programmed to cause the display to show an indication that a zero-point cannot be established before receiving the new signal indicative of the new initial weight detected by the weight detecting device.

5. An electronic scale according to claim 4, wherein the electronic semi-automatic zero device is further programmed to cause the display to show an indication that a zero-point cannot be established before initiating a reset or power cycle for the electronic scale.

6. An electronic scale comprising:
a weight detecting means for detecting a weight of an item;
an electronic initial zero means for (1) receiving a signal indicative of an initial weight detected by the weight detecting means, (2) determining whether the signal indicative of an initial weight is within an initial zero range when the electronic scale is powered on or is reset, and (3) if so for setting an initial zero point based on the initial weight, and (4) if not for receiving a new signal indicative of a new initial weight detected by the weight detecting device; and
an electronic semi-automatic zero means for (1) receiving a signal indicative of a new weight detected by the weight detecting means, (2) determining whether the signal indicative of a new weight is within a semi-automatic zero range when the electronic semi-automatic zero device is activated, and (3) if so for setting a current zero-point based on the new weight, and (4) if not for initiating a reset or power cycle for the electronic scale.

7. A method for establishing zero-points for an electronic scale comprising:
a) via an electronic scale, detecting an initial weight;
b) via an initial zero device, determining if the initial weight falls within an initial zero range;
c) if determined that the initial weight falls within the initial zero range, setting an initial zero-point based on the initial weight;
d) if determined that the initial weight falls outside the initial zero range, returning to step (a) via an electronic scale, detecting an initial weight;
e) detecting activation of a semi-automatic zero device;
f) via the electronic scale, detecting a new weight after detecting activation of the semi-automatic zero device;
g) via the semi-automatic zero device, determining if the difference between the initial weight and the new weight falls within a semi-automatic zero range;
h) if it is determined that the difference between the initial weight and the new weight falls within the semi-automatic zero range, setting a current zero-point based on the new weight;
i) if it is determined that the difference between the initial weight and the new weight falls outside the semi-automatic zero range, via the semi-automatic zero device, initiating either a reset or power cycle procedure for the electronic scale and returning to step (a) via an electronic scale, detecting an initial weight.

8. A method for establishing zero-points for an electronic scale according to claim 7, wherein:
the initial zero range includes an upper limit and a lower limit and the difference between the upper limit and the lower limit is equal to or less than 20% of a maximum weighing capacity of the electronic scale; and
the semi-automatic zero range includes an upper limit and a lower limit and the difference between the upper limit and the lower limit is equal to or less than 4% of the maximum weighing capacity of the electronic scale with respect to the initial zero-point.

9. A method for establishing zero-points for an electronic scale according to claim 8, wherein step (d) if determined that the initial weight falls outside the initial zero range, returning to step (a) via an electronic scale, detecting an initial weight further comprises:
via a display, showing an indication that a zero-point cannot be established before returning to step (a) via an electronic scale, detecting an initial weight.

10. A method for establishing zero-points for an electronic scale according to claim 9, wherein step (i) if it is determined that the difference between the initial weight and the new weight falls outside the semi-automatic zero range, via the semi-automatic zero device, initiating either a reset or power cycle procedure for the electronic scale and returning to step (a) via an electronic scale, detecting an initial weight further comprises:
via the display, showing an indication that a zero-point cannot be established before returning to step (a) via an electronic scale, detecting an initial weight.
